(19) United States
(12) Patent Application Publication
(10) Pub. No.: US 2013/0314728 A1
(43) Pub. Date: Nov. 28, 2013

(54) METHOD OF PRINTING A PRODUCT CODE

(71) Applicant: Robert Weaver, Sandy Springs, GA (US)

(72) Inventor: Robert Weaver, Sandy Springs, GA (US)

(73) Assignee: VIDEOJET TECHNOLOGIES INC., Wood Dale, IL (US)

(21) Appl. No.: 13/983,908

(22) PCT Filed: Feb. 8, 2012
(86) PCT No.: PCT/US12/24227

§ 371 Date: Aug. 6, 2013

Related U.S. Application Data
(60) Provisional application No. 61/440,456, filed on Feb. 8, 2011.

(51) Int. Cl. G06K 15/02

(52) U.S. Cl. CPC G06K 15/02
USPC 358/1.6

(57) ABSTRACT

A method of printing a product code includes providing a printer and a substrate. A product code is determined. The product code includes a plurality of characters and a key code. The key code includes an interleaved character including a combination of a first character and a second character selected from the plurality of characters. The printer is controlled to print the product code on the substrate.

### BACKGROUND

The present disclosure relates to a method of printing a product code to help detect counterfeit items.

Counterfeit items are a large problem in many industries, particularly in developing countries. A variety of methods have been used to allow the verification of the authenticity of items, including holographic labels, RFID tags, and overt and covert codes. Although these methods may provide a way to detect counterfeit items, they also involve additional costs and/or complexity to the production process.

### BRIEF SUMMARY

The present disclosure provides a method of printing a product code to help detect counterfeit items. The product code includes an interleaved character that can be used to detect if the item is counterfeit.

In one aspect, method of printing a product code includes providing a printer and a substrate. A product code is determined The product code includes a plurality of characters and a key code. The key code includes an interleaved character including a combination of a first character and a second character selected from the plurality of characters. The printer is controlled to print the product code on the substrate.

In another aspect, a product with counterfeit protection includes a consumer product and a code printed on the consumer product. The code includes a plurality of characters and a key code. The key code includes an interleaved character including a combination of a first character and a second character selected from the plurality of characters.

The foregoing paragraphs have been provided by way of general introduction, and are not intended to limit the scope of the following claims. The presently preferred embodiments, together with further advantages, will be best understood by reference to the following detailed description taken in conjunction with the accompanying drawings.

### BRIEF DESCRIPTION OF THE DRAWINGS

FIG. 1 shows a first embodiment of a printed product code.

FIG. 2 shows an embodiment of an interleaved character from FIG. 1.

FIG. 3 shows a second embodiment of a printed product code.

FIG. 4 shows an embodiment of an interleaved character from FIG. 3.

FIG. 5 shows a third embodiment of a printed product code.

FIG. 6 shows an embodiment of an interleaved character from FIG. 5.

FIG. 7 shows a rasterized version of the individual components and interleaved character of FIG. 1.

FIG. 8 shows a rasterized version of the individual components and interleaved character of FIG. 3.

FIG. 9 shows a rasterized version of the individual components and interleaved character of FIG. 5.

FIG. 10 shows an embodiment of the individual components and an interleaved code using an inverted character.

FIG. 11 shows an embodiment of the individual components and an interleaved code using a logo and two characters.

FIG. 12 shows an embodiment of the individual components and an interleaved code using three characters.

### DETAILED DESCRIPTION

The invention is described with reference to the drawings in which like elements are referred to by like numerals. The relationship and functioning of the various elements of this invention are better understood by the following detailed description. However, the embodiments of this invention as described below are by way of example only, and the invention is not limited to the embodiments illustrated in the drawings.

A variety of methods have been used to allow the verification of the authenticity of items. Although previous methods may provide a way to detect counterfeit items, they also involve additional costs and/or complexity to the production process. The present disclosure provides a method of printing a product code to help detect counterfeit items. The product code includes an interleaved character that can be used to detect if the item is counterfeit. The method does not require any additional equipment or materials beyond the printer used to provide the existing code on a product, and thus has advantages over prior art methods.

In one aspect, the method of printing a product code includes providing a printer and a substrate. The printer may be any device suitable for printing a code on a substrate, including continuous ink jet, thermal ink jet, drop on demand, or thermal transfer printers, or laser ablation or other laser marking devices. The substrate may be any desired substrate, including porous and non-porous materials, primary and secondary packaging, and the products themselves, including consumer products.

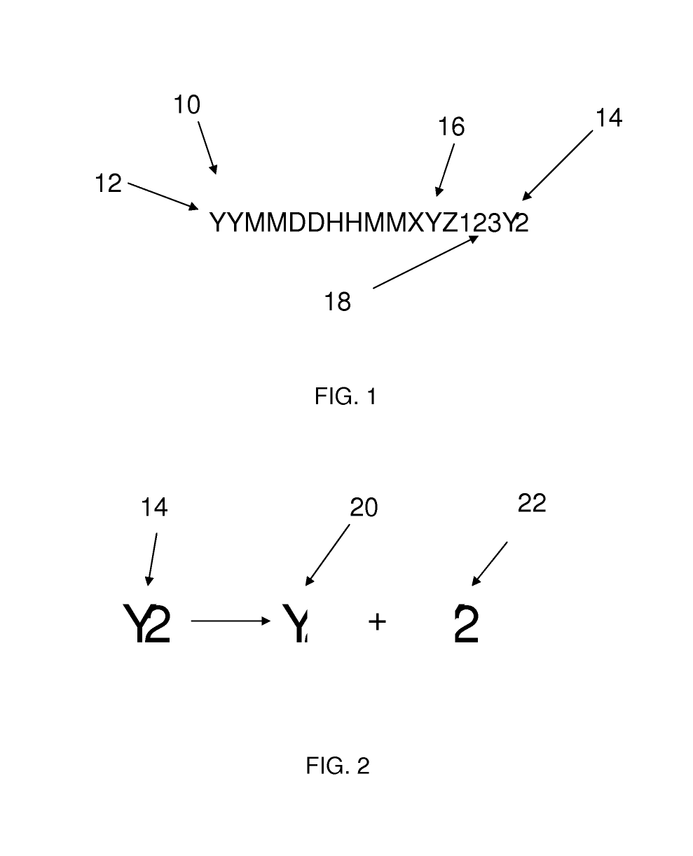

The printer is controlled to print a product code on the substrate. The product code 10 may include a single line, as shown in FIG. 1. The line 12 includes a plurality of characters. In the Example shown in FIG. 1, the letters YY signify the year; MM the month; HH the hour; and MM the minute, which may be depicted as numbers, letters, or other characters. ‘XYZ’ and ‘123’ are further letters and/or numbers may be fixed or may vary with the production of individual products that form the substrate. For example, they may be sequential batch codes or lot numbers. The characters may be alphanumeric characters, characters from any language (including Asian characters), or other symbols. It will be appreciated that a variety of product codes are possible beyond the specific examples depicted herein.

The product code 10 includes a key code which may be used to verify the authenticity of the article. The key code includes an interleaved character 14, which is a combination of two characters from the line of characters. In the Example shown in FIG. 1, the first component character 16 is a ‘Y’ and the second component character 18 is a ‘2’; thus the combined interleaved character is a combination of the Y and the 2.

The controller determines the product code. The characters of the product code other than the interleaved character are selected or determined by methods known in the art and may be based, for example, on the date, the type of product, the location of production, and so forth. The controller also selects the key code. The individual characters that make up the interleaved character may be selected by a suitable algorithm, as described below. The product code and interleaved code are preferably visible to the unaided eye.

By ‘interleaved’ is meant that the component characters generally overlap or otherwise touch, although it will be appreciated that the interleaved characters may not touch in certain circumstances based on the nature of the characters such as the font (e.g. it is possible that two ‘I’s for example, may not touch for certain fonts). Thus, the interleaved character 14 may be thought of as two characters superimposed upon on another, although the exact location and positioning of the two component character may be varied in different embodiments. For example, the characters may be offset in either or both of the vertical and horizontal directions, and may be of the same or different size as the component characters. As shown in FIG. 2, the interleaved character 14 may be applied as two separate characters, a left half 20 and a right half 22, that are printed sequentially to form a combined interleaved character 14. Of course, depending on the printing system, the interleaved character 14 could also be printed as a single character.

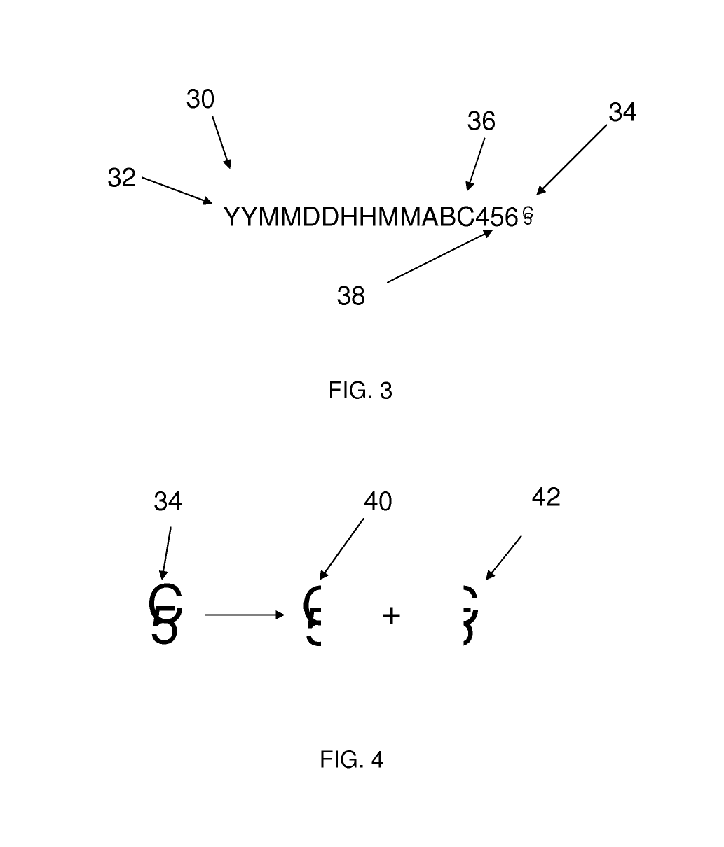

Another embodiment 30 of a single line code is shown in FIG. 3. The line 32 includes a plurality of characters, like line 12 of the previous example. The product code 30 includes a key code which may be used to verify the authenticity of the article. The key code includes an interleaved character 34, which is a combination of two characters from the line of characters. In the Example shown in FIG. 3, the first component character 36 is a ‘C’ and the second component character 38 is a ‘5’; thus the interleaved character 34 is a combination of the C and the 5. In this embodiment, the font of the components of the interleaved character is smaller than the font of the component characters so that the two characters can be offset in the vertical direction but still partially superimposed on top of each other to form the interleaved character 34. As in the previous example, the individual characters that make up the interleaved character may be selected by a suitable algorithm, as described below. As shown in FIG. 4, the interleaved character 34 may be applied as two separate characters, a left half 40 and a right half 42, that are printed sequentially to form a combined interleaved character 34.

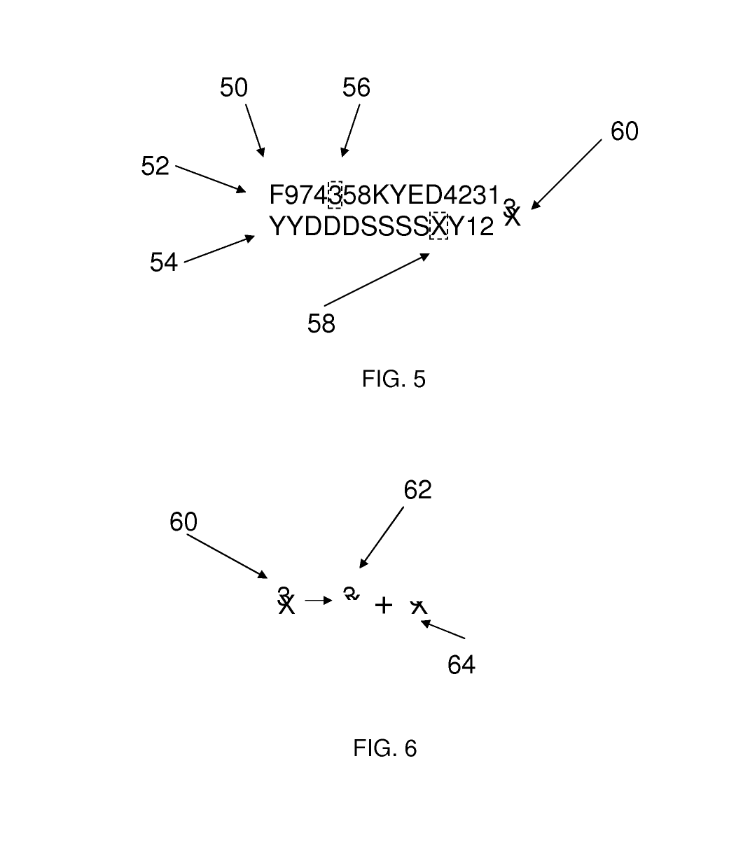

The product code may include two or more lines of code. A third embodiment 50 of a product code shown in FIG. 5 includes two lines. Each of the first line 52 and the second line 54 includes a plurality of characters. As in the previous examples, the characters may be alphanumeric characters, characters from any language (including Asian characters), or other symbols. The product code 50 includes as a key code an interleaved character 60, which is a combination of one character from the first line and one character from the second line. In the Example shown in FIG. 5, the first character 56 is a ‘3’ and the second character 58 is an ‘X’ (the dashed boxes are for illustration purposes); thus the combined interleaved character is a combination of the 3 and the X.

The interleaved character 60 may be positioned lower than the characters in the first line 62 and higher than the characters in the second line 64. As shown in FIG. 6, the interleaved character 60 may effectively be divided into a top portion 62 and a bottom portion 64, where the top portion 62 is printed with the first line 52 and the bottom portion 64 is printed with the second line 54. The first and second lines 62, 62 may be printed separately, at the same time, and with the same or different printers. The first and second lines 62, 64 are preferably printed at the same time and with the same printer, particularly a printer capable of printing two or more lines of code concurrently.

In the embodiment shown in FIGS. 1-6, the key code includes a single interleaved character 14, 34, or 60. However, the present method may use two or more interleaved characters as a key code. In another embodiment, the product code may include more than two lines of characters, and the interleaved character may include a combination of three or more characters. The product code may include a variety of types of codes, including a batch code, a time date code, and a serial number. In one embodiment, one of the first line and the second line includes a fixed code and the other of the first line and the second line includes a variable code.

An algorithm may be used to select which particular characters within the product code are used to provide the interleaved character. For example, the first character may be the mth character and the second character may be the nth character, where ‘m’ and ‘n’ may be the same or change based on a variety of factors, including the characters in the code, the time, date, batch number, etc. The algorithm may be based on encryption factors so that the correct m and n characters can only be selected through the use of a code, making it difficult for counterfeiters to determine the correct code.

The algorithm may include performing a mathematical operation on the components numbers and/or letters of the printed code. A suitable algorithm for a single line code is set forth as follows. A value, S, is formed by simply taking all numeric values (skipping non-numeric characters) in the line of print reading left to right. S1 is formed by removing the even digits (i.e., the second, fourth, etc. digits in the sequence) and S2 is formed by eliminating odd digits. The digital roots of S1 and S2 are then taken yielding C1 and C2. C1 and C2 will be between 1 and 9. The interleaved character will be formed from the characters numbered C1 and C2.

### Example 1

The printed code is 1239051139X7Z123Y2. So, S=123905113971232; S1=13013722; C1=1; S2=2951913; and C2=3Thus, the interleaved character is formed from 1 and 3.

Another suitable algorithm is set forth as follows. A string, S, is formed by simply taking all alphanumeric values (skipping non-alphanumeric characters) in the line of print reading left to right. S1 is formed by removing the even characters in the sequence and S2 is formed by removing the odd characters in the sequence. The digital roots of S1 and S2 are then taken yielding C1 and C2. Alpha characters will be considered to have their value given by the mapping of A=1 through Z=26 (lower and upper case will not be distinguished). C1 and C2 will be between 01 and 9. The interleaved character will be formed from the characters numbered C1 and C2.

### Example 2

The printed code is 123051139X7Z123Y2. Thus, S is 123051139X7Z123Y2; S1 is 135197132; C1 is 5; S2 is 2013XZ2Y; and C2 is 2. Thus, the interleaved character is formed from 5 and 2

A similar algorithm may be used to select which particular characters within the product code are used to provide the interleaved character for a two line code. One suitable algorithm for selecting the characters for the interleaved character for a two line print code is set forth as follows. Two secret keys, key1 and key2, are created using a combination of any character values from 0-255 ASCII. The length of key1 will correspond to the number of characters in the first line of print. The length of key2 will correspond to the number of characters in the second line of print. The first character position m is determined as follows: for each character in the first line of print, add corresponding character from key above. This will form new character array cArray1. Reduce cArray1 to a single number by XOR'ing cArray1 members together. Mod result by the number of characters in first line. This will yield the character position m from the first line to incorporate into the interleaved mark. The second character position n is calculated as follows: for each character in second line of print, add corresponding character from key above. This will form new character array cArray2. Reduce cArray2 to a single number by XOR'ing cArray2 members together. Mod result by the number of characters in second line. This will yield the character position n from line 2 to incorporate into the interleaved mark.

Another suitable algorithm is set forth as follow. All numeric values (skipping letters) in each line of print are added. These totals are designated S1 and S2 for lines 1 and 2 respectively. Two checksums, C1 and C2, are created such that when they are added to S1 and S2, the result is an even multiple of 10. Mod C1 and C2 by the number of characters in printed line 1 and 2 respectively, creating I1 and I2. Character positions, I1 and I2, in lines 1 and 2 are used select the characters that are combined to create the interleaved character. Although example algorithms are provided, any suitable algorithm known in the art may be used with the present methods.

The present method can provide at least two security features to deter counterfeit products. The interleaved character provides an overt security feature that anyone, including a consumer, can use to help verify genuine product. The interleaved character is difficult to print with standard printers, so it will be difficult to copy by counterfeiters. The selection of which characters are used to make the interleaved character can be used to provide a covert security feature, i.e. only someone with knowledge of the specific algorithm used to select the component characters can verify the proper ones are selected. In particular, the same algorithm that determines the code can be used in reverse to determine if the code is genuine. Alternatively, a look up table or the like could be used to determine the authenticity of the code. Other examples of methods of verifying the code include a web site or phone line where a party could input the marked code and receive a response as to whether the code is genuine or not.

The interleaved code is printed similar to the way any conventional character is printed. For a two line code, a digitized raster can be determined by rasterizing the interleaved code or the component characters thereof. The digitized characters for the possible interleaved characters are determined and stored in the printer controller. As an example, the digitized characters may determined for all 1296 combinations of 26 letters and 10 numerals and stored in the printer controller. To print the interleaved character(s), a controller for the printer may dynamically “complete” the code by selecting from pre-configured interleaved characters. For continuous inkjet printing, for example, appropriate drop charge values are determined by conventional methods for each interleaved code and stored in the controller. Then, during printing, after calculating and selecting the appropriate interleaved character from a suitable algorithms (such as those described above), the controller causes the printer to print the interleaved character in the same fashion as a conventional character. Rather than being predetermined, the appropriate printing instructions for the desired interleaved character could also be determined while printing, although this may slow down the printing process. Similar methods may be used, as appropriate, for other types of printing methods.

An example of rasters for the interleaved character of FIG. 1 is shown in FIG. 7. The interleaved character 14 consists of the first character ‘Y’ 16 and the second character ‘2’ 18. The two characters 16, 18 are partially superimposed to form the combined interleaved character 14, with the individual components 16, 18 offset from each other in the horizontal direction.

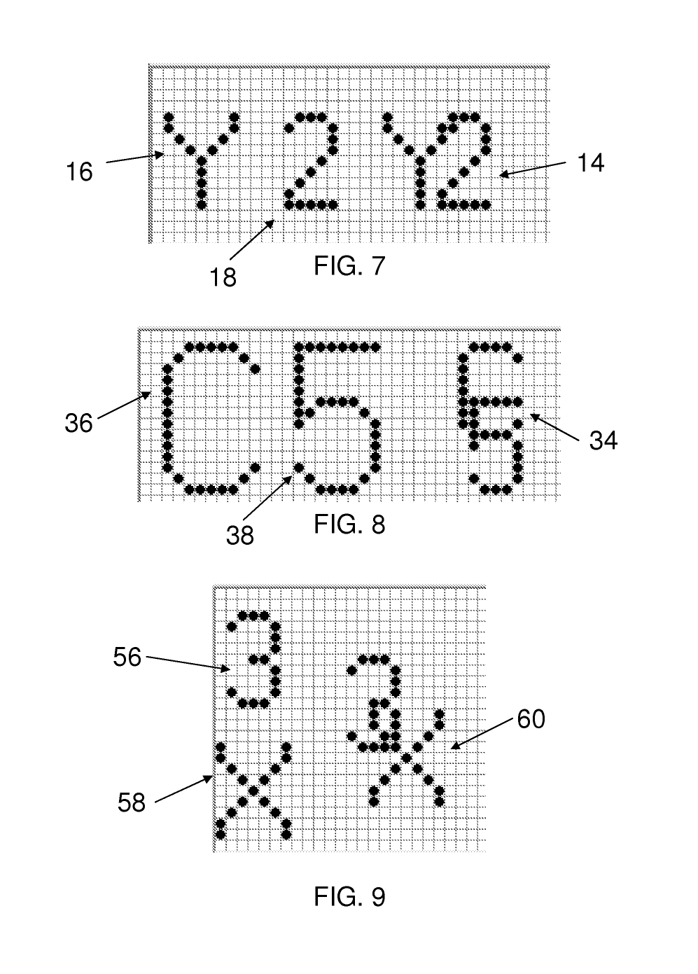

An example of the rasters for the interleaved character of FIG. 3 is shown in FIG. 8. The interleaved character 34 consists of the characters ‘C’ 36 and ‘5’ 38. The two characters 36, 38 are reduced to a smaller font size (to fit on a single line) and superimposed to form the combination interleaved character 34, with the individual components 36, 38 offset from each other in the vertical direction.

An example of the rasters for the interleaved character FIG. 5 is shown in FIG. 9. The interleaved character 60 may be positioned lower than the characters in the first line 62 and higher than the characters in the second line 64. As shown in FIG. 6, the interleaved character 60 may effectively be divided into a tope portion 62 and a bottom portion 64, where the top portion 62 is printed with the first line 52 and the bottom portion 64 is printed with the second line 54. The interleaved code is printed similar to the way any conventional character is printed. For a two line code, a digitized raster may be determined by mapping the interleaved code on a 16 or 24 dot high matrix (for example), with the top part of the code on the top 12 boxes (for printing with the top line) and the bottom part of the code on the bottom 12 boxes (for printing with the bottom line), as shown in FIG. 9.

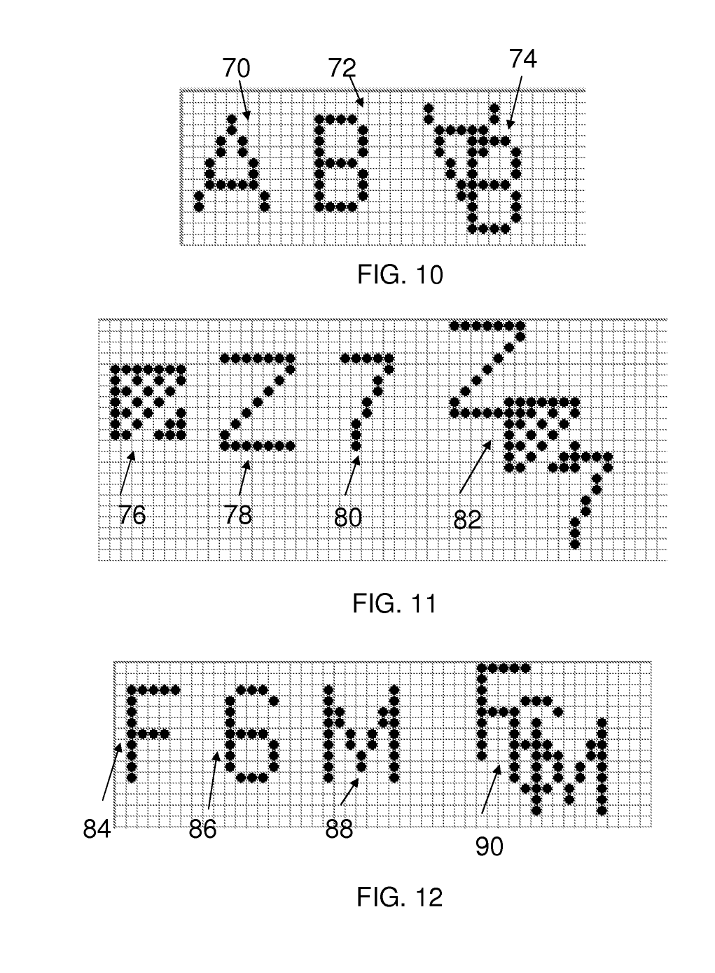

The interleaved character may also include some modification of one, some, or all of the component characters. For example, the characters may be inverted in either or both of the horizontal and vertical directions, rotated, changed in size, or otherwise modified. Such changes may be determined by the code itself or by other factors such as batch code, place of manufacture, time, date, or the like. FIG. 10 shows an embodiment of an interleaved code using an inverted character. The first component character 70 is ‘A’ and the second component character 72 is ‘B’; the interleaved character 74 is an inverted A interleaved with B.

FIG. 11 shows an embodiment of an interleaved code using a logo 76 and two characters 78, 80. The first component character 78 is ‘Z’ and the second component character 80 is ‘7’; the interleaved character 82 is a combination of the logo 76 interleaved with the two characters 78 and 80.

FIG. 12 shows an embodiment of an interleaved code using three characters. The first component character 84 is ‘F’, the second component character 86 is ‘6’, and the third component character 88 is ‘M’. The interleaved character 90 is interleaved with the three characters 84, 86, and 88.

It will be apparent that other combinations and modifications of characters are possible to provide the interleaved character. The product code can also use different colors among the line or lines of code and the interleaved character. The present method may also be used in conjunction with a bar code, such as either a linear bar code or a two dimensional bar code. In one embodiment, the present method and product code does not include a bar code and/or is not used in conjunction with a bar code.

The described and illustrated embodiments are to be considered as illustrative and not restrictive in character, it being understood that only the preferred embodiments have been shown and described and that all changes and modifications that come within the scope of the inventions as defined in the claims are desired to be protected. It should be understood that while the use of words such as “preferable”, “preferably”, “preferred” or “more preferred” in the description suggest that a feature so described may be desirable, it may nevertheless not be necessary and embodiments lacking such a feature may be contemplated as within the scope of the invention as defined in the appended claims. In relation to the claims, it is intended that when words such as “a,” “an,” “at least one,” or “at least one portion” are used to preface a feature there is no intention to limit the claim to only one such feature unless specifically stated to the contrary in the claim. When the language “at least a portion” and/or “a portion” is used the item can include a portion and/or the entire item unless specifically stated to the contrary.

What is claimed is:

1. A method of printing a product code, comprising:
providing a printer;
providing a substrate;
determining a product code, wherein the product code comprises:
a plurality of characters; and
a key code, where the key code comprises an interleaved character comprising a combination of a first character and a second character selected from the plurality of characters; and
controlling the printer to print the product code on the substrate.

2. The method of claim 1 wherein determining the product code comprises using an algorithm to select which characters from the plurality of characters are used to determine the interleaved character.

3. The method of claim 2 wherein the algorithm comprises at least in part summing of the values of the plurality of characters of the product code.

4. The method of claim 1, wherein the product code comprises:
a first line comprising a first portion of the plurality of characters; and
a second line disposed under the first line and comprising a second portion of the plurality of characters;
where the interleaved character comprises one character selected from the first line and one character selected from the second line.

5. The method of claim 4 wherein one of the first line and the second line comprises a fixed code and the other of the first line and the second line comprises a variable code.

6. The method of claim 4 wherein the interleaved character is positioned lower than the plurality of characters in the first line and higher than the plurality of characters in the second line.

7. The method of claim 1 wherein the product code comprises one or more of a batch code, time date code, and a serial number.

8. The method of claim 1 wherein the interleaved character is a combination of two or more alphanumeric characters.

9. The method of claim 1 wherein the interleaved character is a combination of three or more alphanumeric characters.

10. The method of claim 1 wherein the printer is a continuous ink jet printer.

11. The method of claim 1 wherein the printer is a thermal ink jet printer.

12. The method of claim 1 wherein the printer is a laser marking device.

13. The method of claim 1 further comprising using a controller comprising raster information of the plurality of characters and the interleaved character to print the plurality of characters and the interleaved character.

14. The method of claim 1 wherein the substrate is part of a consumer product.

15. A product with counterfeit protection, comprising:
a consumer product;
a code printed on the consumer product, the code comprising:
a plurality of characters; and
a key code, where the key code comprises an interleaved character comprising a combination of a first character and a second character selected from the plurality of characters.

16. The product of claim 15, wherein the product code comprises:
a first line comprising a first portion of the plurality of characters; and
a second line disposed under the first line and comprising a second portion of the plurality of characters;
where the interleaved character comprises one character selected from the first line and one character selected from the second line.

17. The product of claim 15 wherein the interleaved character is positioned lower than the characters in the first line and higher than the characters in the second line.

18. The product of claim 15 wherein the key code comprises a single interleaved character.

19. The product of claim 15 wherein the key code comprises two or more interleaved characters.

20. The product of claim 15 wherein the interleaved character is a combination of two or more alphanumeric characters.

21. The product of claim 20 wherein the two or more alphanumeric characters that provide the interleaved character are of a smaller font than the font of the characters of the first line and the second line.
